(19) United States
(12) Patent Application Publication
(10) Pub. No.: US 2023/0403536 A1
(43) Pub. Date: Dec. 14, 2023

(54) Wi-Fi-Disruption Based Motion Detection and Automation System and Methods

(71) Applicant: CenturyLink Intellectual Property LLC, Broomfield, CO (US)

(72) Inventors: Salvatore Macera, Dresher, PA (US); Monir Bahhage, Snoqualmie, WA (US); Brook Kolluri, McKinney, TX (US)

(73) Assignee: CenturyLink Intellectual Property LLC, Broomfield, CO (US)

(21) Appl. No.: 18/332,662

(22) Filed: Jun. 9, 2023

Related U.S. Application Data
(60) Provisional application No. 63/351,215, filed on Jun. 10, 2022.

(51) Int. Cl. H04W 4/029

(52) U.S. Cl. CPC H04W 4/029; H04W 84/12

(57) ABSTRACT

Systems and methods for configuring and using a Wi-Fi-based motion detection system are provided. Devices connected to a wireless local area network (WLAN) may be configured to provide channel state information regarding radio frequency signals transceived by the devices. The channel state information may be received and used, e.g., by a wireless routing device, to detect motion within an WLAN environment. Detected motion, or the lack thereof, may be considered a Wi-Fi-based motion detection event, and various home-automation and/or security actions may be defined (e.g., through a user interface) to be caused by a determination that a Wi-Fi-based motion detection event has occurred. Among other uses, motion detection information may also be made available to third-party systems (such as emergency services systems), which may permit active querying of Wi-Fi-based motion detection systems to enable first responders to find occupants more quickly in case of an emergency.

### CROSS-REFERENCE TO RELATED APPLICATIONS

This application claims the benefit of U.S. Provisional Application No. 63/351,215 filed Jun. 10, 2022, entitled “Wi-Fi Disruption Based Motion Detection and Automation System and Methods,” which is incorporated herein by reference in its entirety.

### SUMMARY

The present application describes various systems and methods for enabling and using Wi-Fi-based motion detection.

In an aspect, a system is provided comprising at least one processor; and memory, operatively connected to the at least one processor and storing instructions that, when executed by the at least one processor, cause the system to perform a method. In examples, the method comprises: receiving, through a user interface, registration information for two or more devices connected to a wireless local area network (WLAN) operating within a WLAN environment; receiving, through the user interface, at least a first action definition for a first Wi-Fi-based motion detection event; receiving channel state information relating to radio frequency signals transceived by the two or more devices connected to the WLAN; determining, based on the channel state information, that the first Wi-Fi-based motion detection event has occurred; and causing, based on the first action definition, a first action to occur in response to determination that the first Wi-Fi-based motion detection event has occurred.

In another aspect, a method is provided, comprising: receiving, through a user interface, registration information for two or more devices connected to a wireless local area network (WLAN) operating within a WLAN environment; receiving, through the user interface, at least a first action definition for a first Wi-Fi-based motion detection event; receiving channel state information relating to radio frequency signals transceived by the two or more devices connected to the WLAN; determining, based on the channel state information, that the first Wi-Fi-based motion detection event has occurred; and causing, based on the first action definition, a first action to occur in response to determination that the first Wi-Fi-based motion detection event has occurred.

In another aspect, a Wi-Fi routing device is provided, comprising at least one processor; and memory, operatively connected to the at least one processor and storing instructions that, when executed by the at least one processor, cause the Wi-Fi routing device to perform a method. In examples, the method comprises: receiving, through a user interface, registration information for two or more devices connected to a wireless local area network (WLAN) operating within a WLAN environment; receiving, through the user interface, at least a first action definition for a first Wi-Fi-based motion detection event; receiving channel state information relating to radio frequency signals transceived by the two or more devices connected to the WLAN; determining, based on the channel state information, that the first Wi-Fi-based motion detection event has occurred; and causing, based on the first action definition, a first action to occur in response to determination that the first Wi-Fi-based motion detection event has occurred.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts an example system for enabling and using Wi-Fi-based motion detection.

FIG. 2 depicts another example system for enabling and using Wi-Fi-based motion detection.

FIG. 3 depicts an example method for enabling and using Wi-Fi-based motion detection.

FIG. 4 depicts an example computing environment in which aspects of the present application may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Wi-Fi is a wireless networking technology that allows for wireless connection of devices to networks, such as local area networks and/or wide area networks, such as the Internet. Wi-Fi includes protocols known as the 802.11 standard, which is the Institute of Electrical and Electronics Engineers standard for wireless local area networks (WLANs). In examples, as used herein, Wi-Fi refers generally to radio frequency communication protocols, including 802.11, Zigbee, Zwave, Bluetooth, etc. Generally, client devices may use Wi-Fi to communicate with a router on a WLAN. The router may allow the client devices then to communicate with other devices on the WLAN or, e.g., through a modem, to other networks, such as the Internet. Devices that operate both as a router and a modem are sometimes also referred to as gateways. Further, routers may also be connected via wired or wireless connections to additional access points or extender devices, which can help extend the range of the WLAN to allow client devices farther from the router to still communicate with the router and the other devices on the WLAN. Client devices on a WLAN may include computers, mobile phones, televisions, tablets, Internet-of-Things (IoT) devices, etc. As used herein, routers, access points, extender devices, and gateways through which the client devices connect to the WLAN (or to a different network operatively connected to the WLAN) may all be referred to as network access devices.

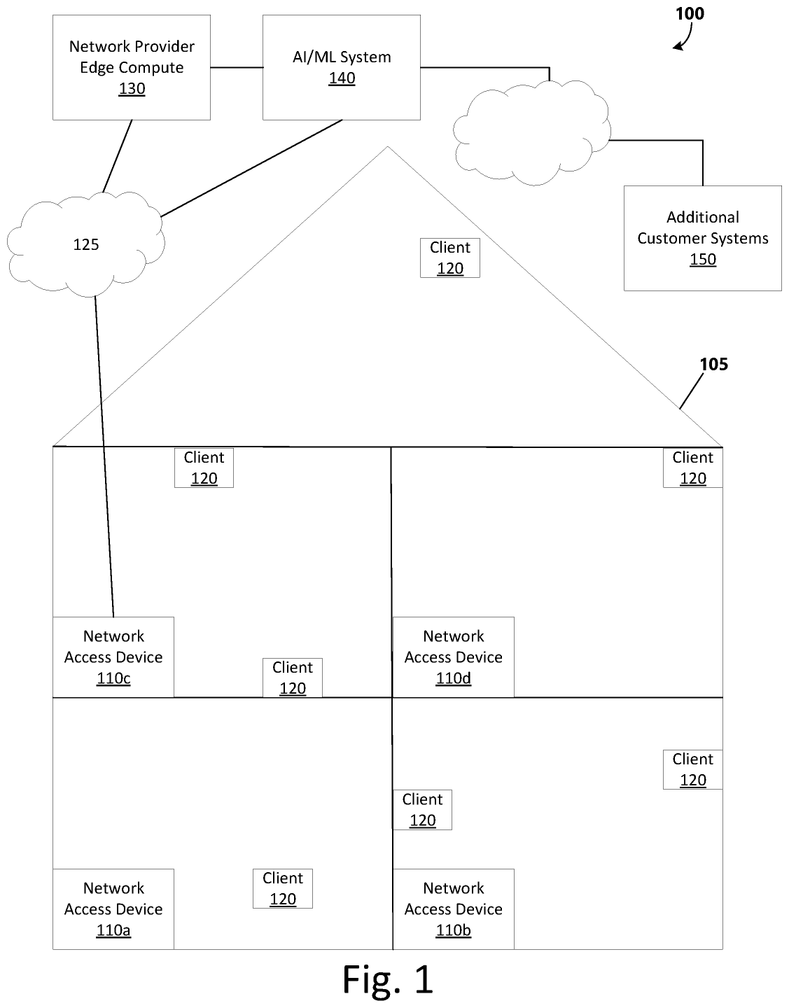

An example system 100 according to aspects of the present application is shown in FIG. 1. A WLAN environment 105 is depicted. In the depicted example, the WLAN environment is a house, but in other examples, WLAN environment 105 may be a business, building, area, or other environment in which network access devices 110 are connected to client devices 120 over a WLAN.

In present examples, Wi-Fi may be used to detect motion in environment 105. In non-exclusive examples, Wi-Fi may operate by propagating radio frequency (RF) waves at 2.4 GHz, 5 GHz, 6 GHz. Other frequency ranges are possible and contemplated. Every WLAN device that receives a Wi-Fi signal may provide feedback to the source of that signal in the form of channel state information and other metadata (collectively referred to herein as CSI). In examples, CSI includes the specific channel state information required by the 802.11 standard and other similar metadata indicating the signal characteristics of a Wi-Fi signal in a WLAN. For example, CSI may be exchanged between two network access devices 110 or between a network access device 110 and a client device 120, among other possibilities. A source device (e.g., one of a network access device 110 or client device 120) may periodically send a sounding signal to test the Wi-Fi connection between devices. CSI is returned by the receiving device to the source device. The CSI is indicative of the signal that is received by a receiving device on the WLAN (e.g., a comparison between the sounding signal that was sent and the signal that was received), and it is typically used by the network access device 110 and/or client device 120 to improve its own performance, but it can also be used to detect motion.

The Wi-Fi RF signal for every signal path between an RF source (e.g., network access device 110) and an RF recipient (e.g., client device 120) exhibits a unique signature based on objects in the environment 105 and the reflection and/or absorption of the signal in the environment 105. The Wi-Fi signal path may include both a direct path (straight line) between transmitter and receiver, as well as multipath components that may include signal paths bouncing off of walls or other objects in the environment 105 before being received the receiver. The multipath signals will have different propagation delays than the direct path signals, and the received signals over the direct path and any multipaths may be expressed as a fine-grained grid between the transmitter and receiver. As a result, when the environment 105 changes due to movement of an object within the environment 105 (or introduction of a new object), the signal paths change, and that is reflected in the CSI returned by the receiving device to the source device.

Motion can be reliably sensed by detecting a disturbance in the CSI. For example, CSI can be plotted over time in a frequency domain, and anomalies indicative of movement can be detected for a particular Wi-Fi channel. In examples, CSI (which may be generated by the network access device(s) 110 and/or client device(s) 120) is collected by the network access device(s) 110 and may be processed on a network access device 110 itself. In other examples, the network access device(s) 110 may provide the CSI to one or more other devices on the WLAN. Alternatively, the network access device(s) 110 may send the collected CSI, e.g., via a modem/gateway or other connection to a different network, to other device(s) that can perform the analysis of the CSI necessary to when motion is detected. For example, the CSI may be provided by network access device 110c (operating as a gateway to network 125) to a network provider edge compute site 130. Network provider edge compute site 130 may perform the necessary calculations to determine when motion is detected within environment 105.

In addition, changes in the CSI for multiple signal paths between one or more network access devices 110 and one or more client devices 120 may be used to triangulate movement and pinpoint the location of the movement within environment 105. For example, if multiple client devices 120 connected to the WLAN are exchanging CSI with multiple network access devices 110 at known locations in the Wi-Fi environment 105, then time-synchronized comparisons of disturbances observed in the CSI for the multiple signal paths can be used to determine an accurate location of movement within the environment 105. In general, the more devices 110, 120 participating in motion detection on the WLAN permits greater coverage of environment 105 and greater accuracy in both movement detection and localization.

As discussed, the CSI may be stored and analyzed by one or more network access devices 110 and/or by other device(s) that are operatively connected to the network access device(s) 110, such as one or more analysis device(s) connected to the WLAN by wired or wireless technologies. For example, the analysis device(s) may comprise server(s) hosted in a cloud (Internet-connected) environment, such as network provider edge compute system 130. In examples, the analysis device(s) may also utilize an artificial intelligence and/or machine learning (AI/ML) system 140 to help recognize patterns in the CSI indicative of movement and to eliminate false positives. In examples, the CSI from multiple WLANs (e.g., additional customer systems 150) may be fed to the AI/ML system 140 so that models to detect and locate movement in Wi-Fi environments can be developed and continuously improved. In some examples, in order to reduce latency, a local copy of the AI/ML model may be periodically downloaded to one or more network access device(s) 110 or locally connected analysis device(s) (e.g., a client device 120) so that movement detection determinations can be made locally. In other examples, it may be advantageous for computing power within a larger network to be used to make such determinations. For example, the AI/ML system 140 may be instantiated at or in close proximity to one or more edge computing locations 130 of a network provider (such as an Internet service provider) to lessen the burden on the limited computing power of network access device(s) 110 while positioning the AI/ML, system 140 logically close to the WLAN to reduce latency and bandwidth usage.

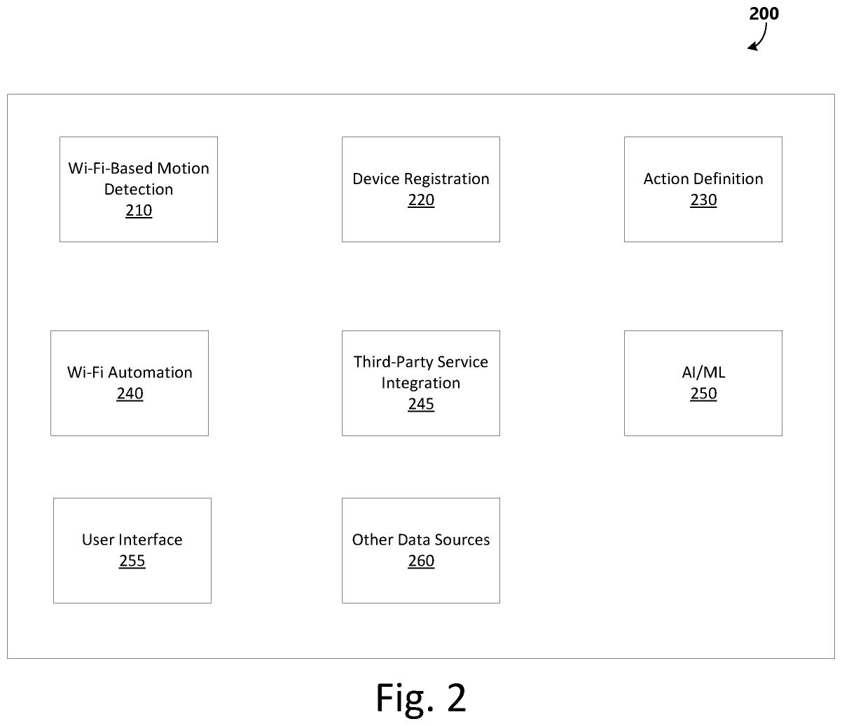

FIG. 2 depicts an example system 200 for detecting and locating Wi-Fi-based motion within an environment and for taking certain actions based on the detected motion. In examples, the system 200 includes a Wi-Fi-based motion detection system 210, a device registration system 220, an action definition system 230, a Wi-Fi automation system 240, a third-party service integration system 245, an AI/ML system 250, a user-interface system 255, and one or more other data sources 260. In examples, some or all of the elements of system 200 may be instantiated in hardware or software implementations on a network access device (such as network access devices 110a-d) on network provider edge compute system 130, on AI/ML system 140, or on one or more other computing devices or systems not pictured in FIG. 1.

In examples, Wi-Fi-based motion detection system 210 comprises one or more software components operating on one or more hardware devices to receive and analyze CSI from one or more devices connected to a WLAN, such as network access devices 110 and/or client devices 120. As discussed, CSI may be routinely collected as part of the 802.11 standard activities by network access devices 110 and client devices 120 using RF transmitters and receivers. Such network access devices 110 and/or client devices 120 may also include a software agent that causes the CSI that is collected to be provided to the Wi-Fi-based motion detection system 210 for the WLAN environment 105. As discussed, the Wi-Fi-based motion detection system 210 may be configured to analyze the CSI over time to determine the WLAN environment CSI baseline (without detected movement) and then detect anomalies indicative of movement within the WLAN environment. In some examples, the Wi-Fi-based motion detection system 210 may receive or have access to an AI/ML model (e.g., from AI/ML system 250) that can be used to differentiate in the CSI patterns between different kinds of movement (human, pet, mechanical, etc.) and to help eliminate false positives.

Further, Wi-Fi-based motion detection system 210 may also determine a location for any detected movement. As discussed, the Wi-Fi-based motion detection system 210 may store the location of any devices participating in the Wi-Fi-based detection (e.g., living room, main bedroom, hallway bathroom, etc.). When Wi-Fi-based motion detection system 210 receives CSI, the CSI may be identified as being indicative of signal(s) between two of the network access device(s) and/or client device(s). The Wi-Fi-based motion detection system 210 can then use the known locations of such devices, the patterns, propagation delays, and angles discernable from the CSI to determine a location of the detected movement.

In examples, device registration system 220 may comprise a computing and storage system configured to receive and store information relating to any devices within the WLAN environment that are participating in the Wi-Fi-based motion detection. For example, the device registration system 220 may cooperate with the user interface system 255 to provide a user interface for the administrator of the WLAN (e.g., the homeowner) to register devices that will be connected to the WLAN and choose whether such devices will participate in motion detection.

In some examples, registration of network access devices 110 and client devices 120 will aid in the accuracy of the Wi-Fi-based motion detection and localization. For example, when an administrator of the WLAN (e.g., a homeowner) adds a new network access device 110 or client device 120 to the WLAN, a user interface may be automatically presented (e.g., generated by user interface system 255 through an application on a mobile device, a website, or otherwise). The user interface may query the user to identify (a) whether the device is stationary or mobile; (b) if stationary, where the device is being installed (e.g., living room, main bedroom, family room, kitchen, basement, etc.); (c) whether the device is associated with a particular occupant (e.g., Dad's phone, light switch in Nick's room, . . . ); etc. In some examples, only stationary network access devices 110 and client devices 120 are used to collect CSI and to detect Wi-Fi-based motion, but the location and connection/disconnection of mobile devices can be used for context information and to determine any resulting actions to be taken based on such motion detection, as discussed below.

In examples, action definition system 230 may comprise a computing and storage system to receive and store defined actions to be taken upon detection of motion using the Wi-Fi-based motion detection system 210. In some examples, the action definition system 230 may receive inputs from, or provide outputs to, one or more of the Wi-Fi-based motion detection system 210, Wi-Fi automation system 240, third-party service integration system 245, AI/ML system 250, user interface system 255, and other data sources 260. For example, action definition system 230 may cooperate with user interface system 255 to present a user interface to an administrator of the WLAN (e.g., via one or more client device(s) 220). The user interface may comprise a series of integrated queries, menus, checkboxes, and other user-interface elements to allow the user to define one or more actions to be taken based on Wi-Fi-based motion detection event(s) and other context information.

For example, Wi-Fi-based motion detection event(s) can be used as the basis of a variety of actions. As a non-exclusive example, security systems can benefit. Video-based and/or audio-based security is limited by the number of cameras and/or microphones installed and the coverage of those cameras. Some areas of a home or business may not be suitable for video cameras or audio recording devices due to privacy concerns (e.g., bathroom areas). Also, video data (and some audio data) is relatively bandwidth intensive, and storage of such data can be expensive. Wi-Fi-based motion detection, on the other hand, may be performed anywhere within the environment that the Wi-Fi RF signals can reach, with limited data processing and storage requirements, and based on CSI that is already being collected for other purposes. Also, the privacy concerns are diminished, as Wi-Fi-based motion detection identifies the motion and the location, but it does not necessarily include any video or audio recording.

Possible security-related actions to be taken based on a Wi-Fi-based motion detection event are numerous. For example, a user may (e.g., in cooperation with user interface system 255) configure the action definition system 230 to provide an alert whenever motion is detected and/or whenever motion is detected and certain context information is present. In some examples, the alert is provided to the user through a user interface managed by user interface system 255. In other examples, the alert may be provided to the user through other communication channel(s) managed by third-party service integration system 245, which may cooperate with third-party email, text, or other communication services. Further, the third-party service integration system 245 may also provide alerts to one or more of an emergency services system (e.g., fire, police, etc.) and/or a security monitoring service.

In some examples, third-party service integration system 245 may include an application programming interface (API) to permit authorized third-party systems to query the system 200 for detected motion information or subscribe to detected motion information published by the third-party service integration system 245. For example, an emergency services system (e.g., fire, police, etc.) may receive a notification of an emergency (e.g., fire, break in, etc.) from a third-party system, such as an alert from security monitoring service, a call from a neighbor, etc. In examples, the emergency service system may be registered with the system 200 and permitted (e.g., through an agreed-upon authentication scheme) to obtain information about the most-recent motion that was detected by Wi-Fi-based motion detection system 200. This may allow, for example, first responders to obtain such detected motion information without system 200 being the source of the alert. In some examples, the most-recent detected motion information is transmitted to and/or stored in a cloud-based system (e.g., network provider edge compute system 130) so that if the on-premises systems (e.g., clients 120 and network access device(s) 110) are compromised (e.g., by a fire), at least the most recent locations where movement was detected can be communicated. In some examples, the most-recent detected motion information is stored periodically and may include information about Wi-Fi motion detection events that indicate that motion was detected or that motion has not been detected during a particular time period.

In some examples, the user may be permitted to delineate certain actions to be taken based on context information (beyond just the Wi-Fi-based detection of motion). For example, the user may define what is considered “expected” versus “unexpected” motion based on context information and define different actions to be taken for each. Context information may include, for example, time of day, known operation of client device(s) 120 (e.g., whether a smart door lock has been legitimately unlocked by an authorized user, whether a smoke alarm is currently triggered, etc.), GPS or other location data from mobile client device(s) 120, metadata available from network access device(s) 110, video data (and facial recognition information available from such video data), audio data (and pattern recognition data related to such audio data, such as whether the audio data indicates the sound of breaking glass, etc.), whether a security system has been enabled (or whether a user has identified that the WLAN environment should be unoccupied), etc.

For example, motion detection at or proximate a time when a homeowner's mobile phone reconnects to the homeowner's WLAN may be classified as “expected” motion, and a security alert that would otherwise have been triggered may be suppressed. That is, if a legitimate occupant of the WLAN environment returns to within range of the WLAN, the router for the WLAN (e.g., network access device 110c) may have context information about the time at which the occupant's mobile phone reconnected to the WLAN. The fact that the mobile phone belongs to the occupant may be known to system 200 due to the registration of that device via device registration system 220. If the time of reconnection is proximate (e.g., within a minute) of the time when motion is detected due to the disturbance of Wi-Fi signals, then the present systems can be configured to suppress certain security actions that would otherwise be triggered. In other examples, intermediate security actions might be triggered, such as turning on a video camera and attempting to identify the person whose motion was detected by facial recognition or alerting a third-party security monitoring service. Other context information about other time-proximate events reported by client device(s) 120 might also be used, such as whether a Wi-Fi enabled garage door opener was activated, whether a Wi-Fi enabled front door lock was legitimately unlocked, GPS or other independent location data from the homeowner's mobile phone, etc.

If motion is, based on the location of the detected motion and the context data, classified as “expected,” then the user may, in examples, configure action definition system 230 to take no action upon motion detection. If the detected motion is classified as “unexpected,” then a user may define actions to be taken, such as sending alerts, using Wi-Fi automation system 240 to turn on certain client device(s) (such as lights or security cameras), etc. In some examples, the detection of motion may be provided by Wi-Fi-based motion detection 210 with a particular confidence value, and the defined action may be to use context information to attempt to confirm or reject the motion as “expected” or “unexpected” prior to proceeding to any alert. System 200 may also use the AI/ML system 250 to create and continually update a model of “expected” motion and context information for a particular WLAN environment 105, such as the time motion is typically detected, whether client device(s) 120 are turned on or off, whether certain mobile client device(s) 120 are connected to the WLAN, etc. The AI/ML model can then be used to further refine decisions whether motion is “expected” or “unexpected,” and action definitions can thereby be further refined. Myriad other actions may be defined based on motion detection and context information.

Wi-Fi-based motion detection events can also be used for automation of client device(s) 120. For example, client devices 120 may be turned on or off based on the motion detection and location determinations from Wi-Fi automation system 240. Nonexclusive examples of Wi-Fi-based client devices 120 that can be controlled using Wi-Fi automation system 240 include: smoke detectors, lighting control systems, appliances, plugs/adapters, sprinkler systems, garage door openers, outlets/switches/dimmers, light bulbs, outdoor lights, video cameras, door locks, video doorbells, water shut-off valves, water heaters, thermostats, water leak detectors, etc. In some examples, the client devices 120 that are controlled using Wi-Fi automation system 240 may comprise client devices that are used to determine whether motion has been detected (e.g., from CSI information provided by such client devices 120). In other examples, client devices 120 that are controlled using Wi-Fi automation system 240 may comprise different client devices than are used to determine whether motion has been detected (e.g., from CSI information provided by such client devices 120). In some examples, the protocol used to transceive CSI for motion detection may be different than that used by Wi-Fi automation system 240 to control a client 120.

In one nonexclusive example, Wi-Fi automation system 240 may be configured to control Wi-Fi enabled light switches, thermostats, appliances, or other home-comfort devices. Wi-Fi automation system 240 may receive, for example, a message from action definition system 230 based on whether motion is detected in the Wi-Fi environment and certain other context information, such as the location of the motion detected and the time of day. For example, a user may define, at action definition system 230, certain Wi-Fi automation actions to be taken if motion is detected in any room after 7:00 a.m., e.g., lights may be turned on, a thermostat may be turned up to a warmer temperature, and a coffee pot may be triggered to start a new pot of coffee, etc. In some examples, the Wi-Fi automation system 240 may be configured to perform certain Wi-Fi automation actions upon a set schedule, but the schedule may be overridden upon the occurrence of detected motion (e.g., indicative of an occupant getting up earlier in the morning than is typical).

In examples, the Wi-Fi based motion detection system 210 may be able to differentiate motion detection between and among different occupants based on, e.g., detected height and gait and/or in conjunction with other context information used to verify the identity of a registered occupant (such as an active connection from that occupant's cell phone, camera data, etc.). In some examples, Wi-Fi automation actions may be defined based on identifying a particular individual as the source of the motion. For example, action definition system 230 may be programmed to suppress all security alerts that would otherwise be triggered by detected motion if the source of the detected motion is determined to be a registered occupant. In other examples, a user may define, at action definition system 230, certain Wi-Fi automation actions to be taken when movement of a first registered occupant is detected, and different Wi-Fi automation actions to be taken when movement of a second registered occupant is detected. For example, a first occupant may define Wi-Fi automation actions to turn on a Wi-Fi enabled coffee pot and turn on a TV upon first detection of that occupant's movement in the morning, while a second occupant may define Wi-Fi automation actions to turn on a music source and increase a thermostat setting upon that occupant's first detected movement.

In some examples, Wi-Fi-based motion detection system 210 may be able to differentiate between types of Wi-Fi motion detection events, such as motion that indicates a fall that is not followed within a threshold amount of time by other movement (such as standing up). In such examples, actions may be defined, at action definition system 230, to alert emergency services and/or designated contacts/family members, etc.

Wi-Fi motion detection information may also be used to make certain recommendations to a user. For example, if network access devices 110 include a router and/or Wi-Fi extenders and/or repeaters, the Wi-Fi motion detection information may be used to (a) determine the area(s) of environment 105 where occupants spend the most time; and (b) make recommendations for additional network access devices 110 in areas of weak coverage but significant detected movement. In other examples, the recommendation may include moving one or more of the network access devices to different areas within the environment to provide better coverage where movement is most often detected.

In other examples, a Wi-Fi motion detection event that triggers an action may, in fact, be the lack of detected motion for more than a threshold amount of time. For example, if no motion is detected for more than twenty-four hours, actions may be defined based on the idea that the house is unoccupied (e.g., the occupants are on vacation or traveling, etc.). In this manner, actions can be defined in action definition system 230 to automatically, e.g., turn down a thermostat, turn off a hot water heater, shut off a water main valve, engage a security system, close window coverings, etc. In other examples, an alert or reminder may be sent to a user to ask whether such actions are desired because the environment appears to be unoccupied. In other examples, a lack of movement for more than a threshold amount of time coupled with other context information (e.g., location of that occupant's cell phone, audio or video data, etc.) may be evidence of a medical emergency for which actions may be defined. Myriad other automation uses of Wi-Fi-based motion detection events are possible.

Third-party service integration system 245, as discussed, may be used to integrate system 200 with one or more outside services, such as a third-party security service, emergency services groups, such as fire departments and police departments, third-party communication services (such as email, text, or other communication systems), etc. Third-party integration system 245 may include application programming interface(s) (API(s)) to allow such third-party services to communicate with one or more elements of system 200 in order to provide context data and/or cause one or more actions defined by action definition system 230 to be executed at or with the third-party service(s). For example, in the case of unexpected motion in a house that is supposed to be unoccupied, the action defined by action definition system 230 may be an alert sent to an emergency service (such as fire and/or police department(s)). In some examples, a user may receive an alert and be required to confirm that the motion is unexpected before an emergency service is alerted. As discussed, in other examples, an API of third-party service integration system 245 may provide callable methods or other interface access to permit authorized third-party systems to query the system 200 for detected motion information or subscribe to detected motion information published by the third-party service integration system 245. This may allow, for example, first responders to obtain such detected motion information without system 200 being the source of the alert.

As discussed, in some examples, context data can be used to refine both the accuracy of Wi-Fi-based motion detection and the resulting actions taken when such motion is detected. In some examples, the context data may be available to, and retrieved by, system 200 from other data sources 260. Other data sources 260 may include, for example, a computing and storage system to store and provide information regarding known operations/logs of client device(s) 120, logs/metadata available from network access device(s) 110, video data (and facial recognition information and/or gait information), audio data (and pattern recognition data related to such video data, such as whether the audio data indicates the sound of breaking glass, etc.), location data for mobile device(s), whether a separate security system has been enabled (or whether a user has identified that the WLAN environment should be unoccupied), etc. Other data sources 260 may also store information about the WLAN environment 105, such as the number of rooms, layout, number of floors, etc. Other data sources 260 may also include computing and storage systems storing information that is relevant to other parts of the single, integrated user interface generated by user interface system 255. For example, other data sources 260 may store or compute information regarding billing, Internet speed, customer account information, etc.

As discussed, AI/ML system 250 may be used by Wi-Fi-based motion detection system 210 to help recognize patterns in the CSI indicative of movement and to eliminate false positives. In examples, the CSI from multiple WLANs (e.g., additional customer systems 150) may be fed to the AI/ML system 250 so that models to detect and locate movement in Wi-Fi environments can be developed and continuously improved. In some examples, in order to reduce latency, a local copy of the AI/ML model may be periodically downloaded to one or more network access device(s) 110 or locally connected analysis device(s) (such as one or more client device(s) 120) so that movement detection determinations can be made locally. In other examples, it may be advantageous for computing power within a larger network to be used to make such determinations. For example, the AI/ML system 250 may be instantiated at, or in close proximity to, one or more edge computing locations 130 of a network provider (such as an Internet service provider). In some examples, model generation and refinement may be instantiated as part of AI/ML system 250 on edge computing location(s) 130, while application of the model in order to make decisions about motion detection (or actions resulting therefrom) may be performed by one or more network access device(s) 110 or client device(s) 120. Accordingly, the functions of AI/ML system 250 may be split between different computing systems.

In examples, the AI/ML system 250 may continually update models based on new information from WLAN environment 105 and additional WLAN environments. The models may, over time, learn to recognize patterns in both CSI and context information (and the combination thereof) to determine (a) whether motion is detected; (b) whether detected motion is “expected”; (c) the source of the motion (e.g., human, pet, machine, etc.); (e) the location of the detected motion; (f) a confidence value for any such determination; etc. In some examples, the AI/ML system 250 may generate a model that is specific to the particular WLAN environment 105. In some examples, models may be universal to WLAN environments. In other examples, a universal model may be used as a starting point, and a local, specific model may be refined as CSI and context data is gathered within the WLAN environment 105.

As discussed, user interface system 255 may cooperate with other elements of system 200 in order to generate particular user interface elements (screens, menus, drop downs, check boxes, etc.) needed for device registration, action definition, third-party service integration, Wi-Fi automation, etc. In examples, a single, integrated user interface is provided by user interface system 255 for device registration, action definition, third-party service integration, Wi-Fi automation, and WLAN management. WLAN management may include setting up the WLAN, setting a password, performing Wi-Fi and Internet speed checks, parental controls for Internet access and connected device management, managing customer account information for an Internet service account with an Internet service provider, billing, etc. The integrated user interface may be accessible through one or more of an application (e.g., on a mobile phone, tablet, laptop, smart television, or other computing device), via web access on a hosted website, and/or otherwise.

For example, the user interface system 255 may be provided or controlled by an Internet service provider that provides to the customer an Internet circuit. The customer may also use customer premises equipment (such as a network access device 110) that is provided by the Internet service provider, or the customer may provide its own customer premises equipment that is adapted to work with the Internet circuit provided by the Internet service provider. The customer premises equipment may cause the WLAN to be implemented by acting as a router for the WLAN and by wirelessly connecting the client devices 120.

The user interface system 255 may be connected to one or more other elements of the system 200 by wired or wireless communications technologies and through a variety of devices, switches, routers, and networks. In one particular example, the customer of an Internet service provider may, through a single integrated user interface on the customer's phone, manage customer account information and billing for Internet and/or Wi-Fi-based motion detection services and purchases related thereto, manage the customer's WLAN (e.g., by providing access to configure the customer premises equipment (e.g., network access device 110)), manage or review statistics regarding the customer's Internet service, enable or disable Wi-Fi-based motion detection, add or remove client device(s) 110 from the WLAN and/or from participating in the Wi-Fi-based motion detection, register client device(s) and network access device(s) and provide or identify context information related to registered devices that will be connected to the WLAN, provide action definition(s) for actions to take based on detected motion and context information, connect to third-party services (such as security monitoring services), enable or disable parental controls for Internet access from certain client device(s) 110, add or remove Wi-Fi enabled client device(s) from participating in Wi-Fi automation, add (or provide access to) context information from other data sources, add or change information describing the WLAN environment, and other functions.

In some examples, the user interface(s) provided by user interface system 255 may also include integrated user interface elements that allow a user to order third-party equipment or services that enable, or are complementary to, the system 200. For example, the user interface system 255 may provide an integrated user interface to allow the user to order an Internet circuit from an Internet service provider, order customer premises equipment (e.g., network access device(s) 110), and automatically configure the customer premises equipment in order to provide Wi-Fi-based motion detection. For example, if the user chooses to enable Wi-Fi-based motion detection through the integrated user interface, the customer premises equipment may be automatically configured by the Internet service provider (either prior to delivery or upon a remote “call home” configuration process) to include a software agent to forward collected CSI and/or context information to Wi-Fi-based motion detection system 210. In other examples, Wi-Fi-based motion detection may be automatically enabled (or may be default enabled unless actively disabled through the integrated user interface).

Further, the integrated user interface provided by user interface system 250 may allow users to order additional equipment and services that are automatically integrated into the system 200. For example, the integrated user interface may include screens to show logged activity by the system 200 (e.g., motion detected at 7:03 a.m. in the living room, John's phone connected to WLAN at 2:30 p.m., front door lock disengaged at 5:13 p.m., etc.). That same user interface may integrate user interface elements to allow the user to order additional network access devices 110 (such as Wi-Fi extenders). Among other things, the integrated user interface may provide a visual representation of which portions of the WLAN environment 105 are currently covered by Wi-Fi coverage and/or by Wi-Fi motion detection coverage and encourage the user to order additional extenders to extend the coverage for both.

In other examples, a user may be provided, through the integrated user interface, an opportunity to order a third-party security monitoring service through the Internet service provider. For example, when Wi-Fi-based motion detection is confirmed, a defined action (by action definition system 230) may be to turn on a video camera and or activate any available microphones connected on the WLAN in an attempt to confirm that the motion is unexpected and/or indicative of an emergency or a crime. In examples, system 200 may provide an alert to such third-party service, which may use human operators and/or automation to confirm unexpected motion through the audio and/or visual context information and, in some cases, alert emergency services and/or take other action. In some examples, system 200 causes the alert and any audio or video data collected (e.g., by client device(s) 120) to such third-party security service if and when Wi-Fi-based motion detection occurs. The Internet service provider may, in examples, preconfigure third-party service integration system 245 with APIs to work with systems of the third-party security service and offer such service to customers via the integrated user interface. Offerings of other third-party services through the integrated user interface are also possible.

Offering of other related devices through the integrated user interface is also possible. For example, an Internet service provider may offer, via the single, integrated user interface provided by user interface system 250, to sell one or more client device(s) 120. In examples, the client device(s) 120 (e.g., video doorbell, smart light switch, smart thermostat, etc.) may be automatically configured (when ordered through the integrated user interface) to work correctly with the Wi-Fi-based motion detection system 210 without user intervention. For example, either prior to delivery or upon a remote “call home” configuration process, the client device(s) 120 that are ordered may be configured to include a software agent to forward collected CSI and/or context information to Wi-Fi-based motion detection system 210.

In some examples, the user interface may also identify, to a user, other Wi-Fi enabled devices in the home that are not currently connected to the WLAN or that are not currently enabled for use with the Wi-Fi-based motion detection system 210. For example, some routers may be configured to discover the media access control (MAC) address of any devices that are in range. The integrated user interface can then identify the devices that are not currently being used for Wi-Fi-based motion detection and encourage the WLAN administrator to add such devices to increase accuracy.

Thus, the integrated user interface provided by user interface system 250 may provide a dashboard of status and activity, and the ability to manage and control, (a) the user's Internet connection; (b) the WLAN; (c) Wi-Fi-based motion detection; (d) security services; (e) available real-time and recorded video and audio information from the WLAN environment; (f) account information; (g) network access device(s); (h) connected client device(s); (i) billing information, (j) parental controls for Internet access; (k) connected device registration; (l) Internet speed tests, among other things.

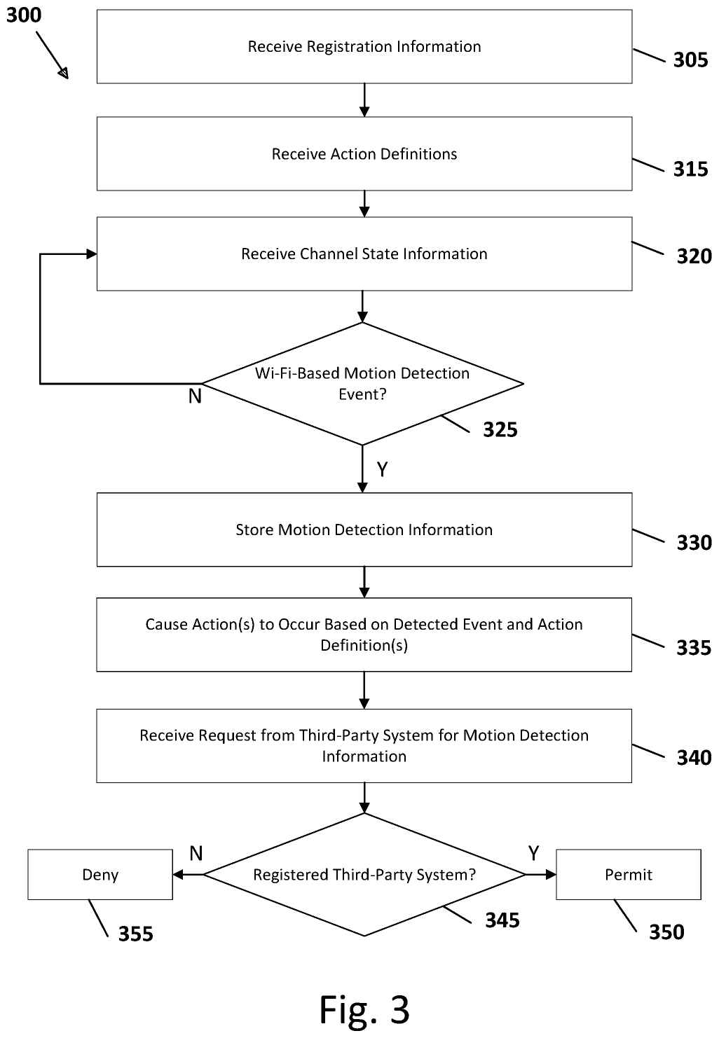

FIG. 3 depicts an example method 300 in accordance with aspects of the present disclosure. In nonexclusive examples, the method 300 may be performed, in whole or in part, by a network access device, such as network access device 110. For example, method 300 may be performed by a Wi-Fi routing device. In other examples, some or all of the method 300 may be performed by other systems described in relation to FIGS. 1 and 2 or other suitably configured systems.

Flow begins at operation 305, where registration information is received. As discussed, registration information may include information about, e.g.: (a) devices participating in Wi-Fi-based motion detection, such as network access device(s) 110 or client device(s) 120; (b) devices registered to accept instructions from system 200, e.g., to effect a defined action in response to detection of Wi-Fi-based motion detection event; (c) devices connected to the WLAN that provide context information to system 200 in determining whether a Wi-Fi-based motion detection event has occurred and/or whether motion is expected or unexpected; (d) registered occupants of the WLAN environment (such as known individuals who live or work in the environment); and (e) registered third-party systems that can participate either in providing context information to system 200 or in retrieving motion detection information from system 200. In examples, registration information may include identifiers of devices (e.g., media access control (MAC) addresses, Internet Protocol (IP) addresses, related phone number, or other identifiers). Registration information may also include location of the devices participating in the Wi-Fi-based motion detection in the WLAN environment. In addition, registration information may include account information (e.g., username, password, etc.) for third-party systems to enable system 200 to communicate effectively with such third-party systems. Registration information for known occupants may include name, username, physical information (height, facial scan, gait information/profile, etc.), and an association of particular devices (e.g., client devices 120) that are associated with such individual(s) (e.g., an occupant's cell phone), etc. In examples, registration information may be received through a user interface presented on a client device 120, via an on-line portal, or otherwise. In other examples, some registration information may be programmatically exchanged, e.g., between network access device 110 and client device 120 when the client device 120 connects to the WLAN enabled by the network access device 110.

Flow proceeds to operation 315, where action definitions are received. In examples, action definitions include (a) definition of a Wi-Fi-based motion detection event; and (b) one or more actions to be effected upon detection of such event. As discussed, a Wi-Fi-based motion detection event may be defined as, in examples, (a) any detected motion; (b) detected motion that is classified as “unexpected” (e.g., after consideration of context information); or (c) lack of detected motion for a threshold period of time, among other options. Further, the action(s) defined to be taken based on detection of a defined event may be universal (e.g., the same action to be taken whenever the event is detected), or it may be defined as dependent on other factors. For example, different actions can be defined for the same event based on a classification of which registered occupant is determined to be moving, based on other context information (e.g., time of day, ambient temperature, etc.), or otherwise.

Flow proceeds to operation 320, where channel state information is received. As discussed, channel state information that is transceived between and among devices participating in Wi-Fi-based motion detection in the WLAN can be used to sense disturbances in the WLAN environment and triangulate motion.

At operation 325, a determination is made whether a Wi-Fi-based motion detection event has been detected. As discussed, the determination at operation 325 may include a determination whether all of the criteria for an event defined at operation 315 have been met. In examples, the determination at operation 325 is made periodically. As discussed, the determination at operation 325 may be made initially based on the channel state information. For example, a confidence value may be determined based solely on the channel state information. However, context information may then be used to adjust the confidence value, and a determination that a defined event has been detected may be made only if the adjusted confidence value exceeds a defined threshold. In examples, the determination at operation 325 may include determining that (a) motion has been detected; (b) the motion is likely related to a registered occupant (e.g., as determined from the individual's height, or gait, etc.); (c) the individual detected to be moving has a device registered to him/her (e.g., a mobile phone); and (d) context information from that registered device increases (or decreases) the confidence that the motion is related to the registered occupant (e.g., by determining whether the device is currently connected to the WLAN). As discussed, in some examples, Wi-Fi-based motion detection events may be defined based on a determination both that motion has been detected and that such motion is unexpected. For example, during registration, all security-related actions (calling emergency services, generating alerts, etc.) may be suppressed if the motion is detected to be associated with one of the registered occupants because any such motion is expected. As discussed, whether a detected motion is classified as expected or unexpected may include evaluating a confidence value based on related context information following a determination that motion has been detected.

If no Wi-Fi-based motion detection event is detected at operation 325, flow proceeds back to operation 320, where the system waits for additional channel state information. In addition, operations 305 and 315 may be repeated at any point during method 300.

If a Wi-Fi-based motion detection event is detected at operation 325, flow proceeds to operation 330, where motion detection information is stored. In examples, the motion detection information may include (a) a log of any Wi-Fi-based motion detection events that have been detected; (b) a time-stamped log of any motion that has been detected (regardless of whether it meets the criteria for a defined event); (c) any actions triggered by Wi-Fi-based motion detection events, among other information. Although operation 330 is depicted as occurring only after a Wi-Fi-based motion detection event is detected at operation 325, it may occur, in some examples, even if flow branches “No” from operation 325. For example, as discussed, even if no action is to be taken as a result of detected motion (e.g., because the motion was expected or did not meet an action criteria), a log of detected motion may still be useful.

At operation 335, action(s) is/are caused to occur based on the detected event and the applicable action definition. For example, the action(s) may include an alert or an automated action by another device connected to the WLAN or otherwise reachable by system 200. In some examples, the action(s) may include a first action, which is a request (e.g., email, text, phone call, etc.) for confirmation that a second action should be taken. For example, if a defined Wi-Fi-based motion detection event is detected, system 200 may send a message to a user asking to confirm that some other action should be taken. When the second action is confirmed by return message, the second action may be taken (or caused to be taken).

In some examples, flow proceeds to operation 340, where a request is received from a third-party system for access to motion detection information. As discussed, system 200 may allow for registration of a third-party system to permit such third-party system to access motion detection information from system 200. In non-exclusive examples, an emergency services system (e.g., a computing system used by fire or police department(s)) may receive notification of an emergency through other channels (e.g., a phone call, security system alert, etc.). The emergency services system may then, e.g., request access to motion detection information. For example, the system 200 may include an API to allow programmatic access to methods for retrieving motion detection information. As discussed, motion detection information may include a log of all motion detected in the WLAN environment, whether or not it resulted in detection of a Wi-Fi-based motion detection event. For example, a fire department may use the last-known location of detected motion in order to more quickly locate individuals within a structure.

At operation 345, a determination is made whether the third-party system is registered. For example, the third-party system may be required to authenticate using credentials generated during the registration process for such third-party system. If the third-party system is registered, access to the motion detection information is permitted at operation 350. Otherwise, access is denied at operation 355. In examples, some or all of the operations of method 300 may be repeated periodically or continuously during operation of system 200.

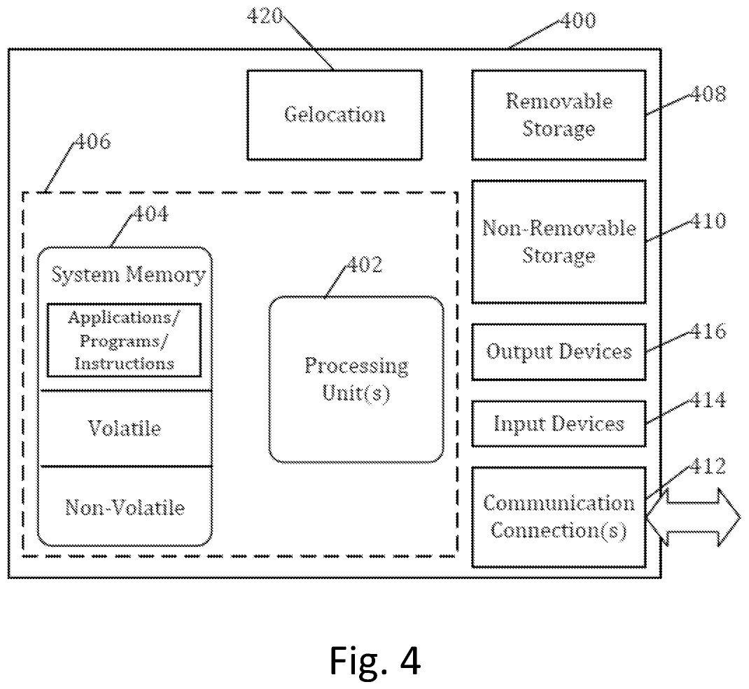

FIG. 4 depicts an example computing environment 400 in which aspects of the present application may be practiced. Operating environment 400 that may be implemented by, or comprise, a network access device 110, a client device 120, system 200, and/or other computing devices within the systems discussed herein. In its most basic configuration, operating environment 400 typically includes at least one processing unit 402 and memory 404. The processing unit may be a processor, which is hardware. Depending on the exact configuration and type of computing device, memory 404 (storing, instructions to perform the motion detection techniques disclosed herein) may be volatile (such as RAM), non-volatile (such as ROM, flash memory, etc.), or some combination of the two. This most basic configuration is illustrated in FIG. 4 by dashed line 406. The memory 404 stores instructions that, when executed by the processing unit(s) 402, perform the processes and operations described herein. Further, the operating environment 400 may also include storage devices (removable 408, and/or non-removable 410) including, but not limited to, solid-state, magnetic disks, optical disks, or tape. Similarly, the operating environment 400 may also have input device(s) 414 such as keyboard, mouse, pen, voice input, etc. and/or output device(s) 416 such as a display, speakers, printer, etc. Additional communication connections 412 may also be included that allow for further communication with LAN, WAN, point-to-point, etc. Operating environment 400 may also include geolocation devices 420, such as a global positioning system (GPS) device.

Operating environment 400 typically includes at least some form of computer readable media. Computer readable media can be any available media that can be accessed by processing unit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is tangible and non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

Aspects of the present invention, for example, are described above with reference to block diagrams and/or operational illustrations of methods, systems, and computer program products according to aspects of the invention. Systems depicted as blocks may be communicatively connected to one or more other systems described, whether or not such connection(s) is/are drawn as such. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C. In addition, as used herein, the terms “data” and “information” may be used interchangeably.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system, comprising:
at least one processor; and
memory, operatively connected to the at least one processor and storing instructions that, when executed by the at least one processor, cause the system to perform a method, the method comprising:
receiving, through a user interface, registration information for two or more devices connected to a wireless local area network (WLAN) operating within a WLAN environment;
receiving, through the user interface, at least a first action definition for a first Wi-Fi-based motion detection event;
receiving channel state information relating to radio frequency signals transceived by the two or more devices connected to the WLAN;
determining, based on the channel state information, that the first Wi-Fi-based motion detection event has occurred; and
causing, based on the first action definition, a first action to occur in response to determination that the first Wi-Fi-based motion detection event has occurred.

2. The system of claim 1, wherein the method further comprises:
receiving a registration of a third-party system;
storing motion detection information;
providing, based on the registration, access to the motion detection information to the third-party system.

3. The system of claim 2, wherein the third-party system is an emergency services system, wherein the motion detection information comprises a location of last-detected movement in the WLAN environment, and wherein providing access to the motion detection information comprises:
providing an application programming interface;
receiving a query from the emergency services system for the motion detection information through the application programming interface; and
returning the motion detection information in response to the query.

4. The system of claim 1, wherein the method further comprises:
determining a confidence value, based on the channel state information, that the first Wi-Fi-based motion detection event has occurred;
obtaining context data related to the first Wi-Fi-based motion detection event; and
adjusting the confidence value based on the context data;
wherein determining that the first Wi-Fi-based motion detection event has occurred is based on the adjusted confidence value.

5. The system of claim 4, wherein the method further comprises:
receiving information about a first occupant;
receiving information about a third device associated with the first occupant; and
determining that the first Wi-Fi-based motion detection event is related to the first occupant.

6. The system of claim 5, wherein the context data comprises information about a state of the third device that is associated with the first occupant and connected to the WLAN.

7. The system of claim 1, wherein the first Wi-Fi-based motion detection event comprises an absence of detected motion within the WLAN environment for at least a threshold period of time.

8. The system of claim 1, wherein the first action definition includes a second action, wherein the first action comprises sending a notification asking to confirm that the second action should be taken, and wherein the method further comprises:
receiving confirmation of the second action; and
causing the second action to be performed.

9. The system of claim 1, wherein the first action comprises controlling a third device connected to the WLAN that is different from the two or more devices.

10. The system of claim 1, wherein determining that the first Wi-Fi-based motion detection event has occurred comprises determining that unexpected motion in the WLAN environment has been detected, wherein the method further comprises:
determining, based on the channel state information, that motion has been detected;
obtaining context data related to the detected motion; and
determining a confidence value, based on the context data, that the motion is unexpected;
wherein determining that the first Wi-Fi-based motion detection event has occurred is based on the confidence value exceeding a threshold.

11. The system of claim 1, wherein the method further comprises:
receiving device registration information including: (a) identifiers and locations for the two or more devices; and (b) identification of at least a third device, connected to the WLAN, that is different from the two or more devices providing the channel state information;
wherein the first action comprises controlling the third device.

12. A method, comprising:
receiving, through a user interface, registration information for two or more devices connected to a wireless local area network (WLAN) operating within a WLAN environment;
receiving, through the user interface, at least a first action definition for a first Wi-Fi-based motion detection event;
receiving channel state information relating to radio frequency signals transceived by the two or more devices connected to the WLAN;
determining, based on the channel state information, that the first Wi-Fi-based motion detection event has occurred; and
causing, based on the first action definition, a first action to occur in response to determination that the first Wi-Fi-based motion detection event has occurred.

13. The method of claim 12, further comprising:
receiving a registration of a third-party system;
storing motion detection information;
providing, based on the registration, access to the motion detection information to the third-party system.

14. The method of claim 13, wherein the third-party system is an emergency services system, wherein the motion detection information comprises a location of last-detected movement in the WLAN environment, and wherein providing access to the motion detection information comprises:
providing an application programming interface;
receiving a query from the emergency services system for the motion detection information through the application programming interface; and
returning the motion detection information in response to the query.

15. The method of claim 14, further comprising:
determining a confidence value, based on the channel state information, that the first Wi-Fi-based motion detection event has occurred;
obtaining context data related to the first Wi-Fi-based motion detection event; and
adjusting the confidence value based on the context data;
wherein determining that the first Wi-Fi-based motion detection event has occurred is based on the adjusted confidence value.

16. The method of claim 15, further comprising:
receiving information about a first occupant;
receiving information about a third device associated with the first occupant, wherein the context data comprises information about a state of the third device that is associated with the first occupant and connected to the WLAN; and
determining that the first Wi-Fi-based motion detection event is related to the first occupant.

17. The method of claim 11, wherein the first Wi-Fi-based motion detection event comprises an absence of detected motion within the WLAN environment for at least a threshold period of time.

18. A Wi-Fi routing device, comprising:
at least one processor; and
memory, operatively connected to the at least one processor and storing instructions that, when executed by the at least one processor, cause the Wi-Fi routing device to perform a method, the method comprising:
receiving registration information for two or more devices connected to a wireless local area network (WLAN) enabled by the Wi-Fi routing device within a WLAN environment;
receiving at least a first action definition for a first Wi-Fi-based motion detection event;
receiving channel state information relating to radio frequency signals transceived by the two or more devices connected to the WLAN;
determining, based on the channel state information, that the first Wi-Fi-based motion detection event has occurred; and
causing, based on the first action definition, a first action to occur in response to determination that the first Wi-Fi-based motion detection event has occurred.

19. The Wi-Fi routing device of claim 18, wherein the method further comprises:
receiving a registration of a third-party system;
storing motion detection information;
providing, based on the registration, access to the motion detection information to the third-party system.

20. The Wi-Fi routing device of claim 18, wherein the first Wi-Fi-based motion detection event comprises an absence of detected motion within the WLAN environment for at least a threshold period of time.
